(19) United States
(12) Patent Application Publication
(10) Pub. No.: US 2012/0327126 A1
(43) Pub. Date: Dec. 27, 2012

(54) METHOD AND APPARATUS FOR CAUSING PREDEFINED AMOUNTS OF ZOOMING IN RESPONSE TO A GESTURE

(75) Inventors: Jouni Tapio Solismaa, Tampere (FI); Mikko Antero Nurmi, Tampere (FI)

(73) Assignee: Nokia Corporation

(21) Appl. No.: 13/169,560

(22) Filed: Jun. 27, 2011

(51) Int. Cl. G09G 5/373

(52) U.S. Cl. 345/661

(57) ABSTRACT

A method, apparatus and computer program product are provided to permit a user to utilize a gesture, such as a pinching gesture, to select from among one or more predefined amounts of zooming. In the context of a method, the method may include receiving input representative of a gesture associated with zooming of a view and then causing one or more indicators of respective predefined amounts of zooming to be displayed in response to receiving the input. In response to selection of a respective indicator, the method may also cause the view to be zoomed in accordance with the predefined amount of zooming associated with the respective indicator.

### TECHNOLOGICAL FIELD

Some example embodiments of the present invention relate generally to user interface technology and, more particularly, relate to a method and apparatus for controllably zooming a view by predefined amounts in response to a gesture.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. As such, a mobile terminal may be able to access a substantial amount of content, such as photos or other images, maps, text or other documents, calendars, games and the like. A substantial amount of the content that is accessible by a mobile terminal may be displayed as a view for consideration by the user.

Once a view is displayed, users commonly desire to zoom the view. For example, a user may wish to zoom in an image in order to see a finer level of detail of a portion of the image. Conversely, a user may wish to zoom out in order to see a more expansive field of view, albeit with fewer details. In instances in which a view is displayed upon a touch screen display, the user may provide input regarding zooming of the view by providing a pinching gesture. In this regard, a user may indicate that an image is to be zoomed in by a pinching gesture in which the user's fingers are spread further apart. Alternatively, a user may indicate that an image is to be zoomed out by providing a pinching gesture in which the user's fingers are brought closer together.

In an instance in which the zooming is controlled by a pinching gesture, the amount of zooming may be defined by the magnitude of the pinching gesture, that is, the extent by which the user's fingers move, either toward one another or away from one another. In this regard, greater amounts of zooming may be provided in response to a pinching gesture in which the user's fingers are moved a relatively large amount, while lesser amounts of zooming may be provided in response to a pinching gesture in which the user's fingers are moved by a smaller distance.

In providing direction for the zooming of an image with a pinching gesture, a user may find it difficult to cause an image to be zoomed by a predefined amount. Such difficulty is generally exacerbated in instances in which a touch screen display is relatively small. For example, some touch screen displays, such as those provided by mobile terminals, may be relatively small and the user's interaction with a relatively small touch screen display may be imprecise. For example, a user may provide a pinching gesture with an intent to cause a predefined amount of zooming, such as 100%, 75%, 50% or the like. Because of the relative imprecision in the input provided by a pinching gesture, particularly for a pinching gesture input via a relatively small touch screen display, the actual amount of zooming may be some other amount, such as 97.3% instead of 100%, 63% instead of either 75% or 50% or the like. Not only does such imprecision result in the presentation of a zoomed view that has a different amount of zooming than that desired by the user, but views that are zoomed to such irregular amounts may have visual artifacts, jagged lines or otherwise be of a lower quality than the original view. Further, zooming of a view, such as a map, may also be slower than desired as it may take a sequence of inputs in order to zoom from a country view, to a state view, to a city view to a street view.

### BRIEF SUMMARY

A method, apparatus and computer program product are provided to permit a user to utilize a gesture, such as a pinching gesture, to select from among one or more predefined amounts of zooming. As such, a user may more readily cause an view to be zoomed in a desired manner, thereby producing the view anticipated by the user while also potentially reducing visual artifacts, jagged lines and the like in the resulting view. The method, apparatus and computer program product of one example embodiment does not limit a user to the selection of one or more predefined amounts of zooming with the gesture, but also allows the user to select amounts of zooming that are different than the predefined amounts with the gesture. As such, a user may enjoy not only the ability to readily select one or more predefined amounts of zooming with a gesture, but may also enjoy the freedom of selecting any other amount of zooming with the gesture, if so desired.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for causing a view to be zoomed by a predefined amount in response to a gesture in accordance with an example embodiment of the present invention;

FIG. 3 is a flow chart illustrating operations performed according to an example embodiment of the present invention;

FIG. 4 is a representative display prior to zooming of the image;

FIG. 5 is a representative display in which the image has been zoomed by 150% and indicators indicative of predefined amounts of zooming of 200% and 300% are displayed in accordance with an example embodiment of the present invention;

FIG. 6 is a representative display of an image that has been zoomed by 200% and which illustrates the indicator indicative of a predefined amount of zooming of 200% being highlighted and enlarged in accordance with an example embodiment of the present invention; and

FIG. 7 is a representative image illustrating a plurality of indicators of different predefined amounts of zooming including predefined amounts of zooming in and zooming out in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As described below, a method, apparatus and computer program product are provided in accordance with an example embodiment for facilitating zooming of a view in response to a gesture, such as a pinching gesture. While the zooming of an image will be described below, the method, apparatus and computer program product may facilitate zooming of a variety of views in addition to images including views of a map, a calendar or the like. In this regard, a method, apparatus and computer program product of one embodiment of the present invention provide indicators of respective predefined amounts of zooming to facilitate the selection of a predefined amount of zooming with the gesture. However, the method, apparatus and computer program product of one embodiment of the present invention still permit a selection of other amounts of zooming that are not represented by one or more indicators such that a user can freely select any amount of zooming with the gesture.

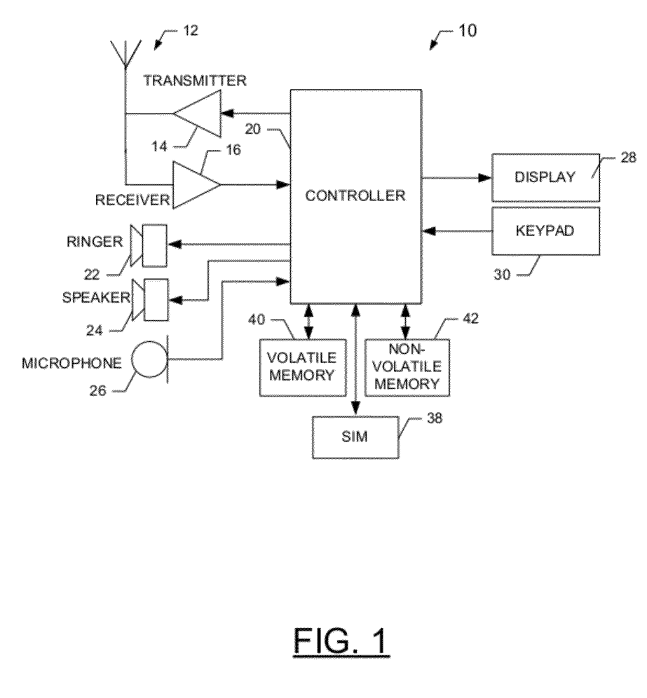

FIG. 1, one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

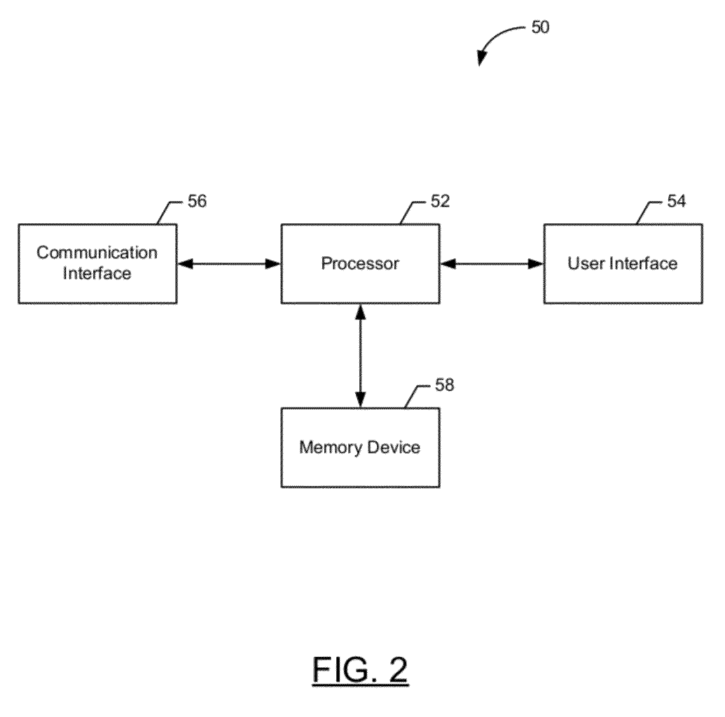

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 52 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display), touch surface either with or without a co-located display or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

As noted above, the display 28 may be a touch screen display. In this embodiment, the touch screen display may be configured to visually present graphical information to a user. The touch screen display, which may be embodied as any known touch screen display, may also include a touch detection surface configured to enable touch recognition by any suitable technique, such as resistive, capacitive, infrared, strain gauge, surface wave, optical imaging, dispersive signal technology, acoustic pulse recognition, or other like techniques. The touch screen display may include all of the hardware necessary to detect a touch when contact is made with the touch detection surface. A touch event may occur when an object, such as a stylus, finger, pen, pencil or any other pointing device, comes into contact with a portion of the touch detection surface of the touch screen display in a manner sufficient to register as a touch. In this regard, for example, a touch could be a detection of a change in capacitance (e.g., due to physical contact with the surface of the screen or close proximity “hovering” of an object relative to the surface of the screen), pressure on the touch detection surface above a particular pressure threshold over a given area, or the like. The touch screen display may also be configured to generate touch event location data indicating the location of the touch event on the screen. Touch screen display may be configured to provide the touch event location data to other entities (e.g., the processor 20).

In some embodiments, touch screen display may be configured to detect a touch followed by motion across the touch detection surface, which may also be referred to as a gesture. In this regard, for example, the movement of a finger across the touch detection surface of the touch screen display may be detected and touch event location data may be generated that describes the gesture generated by the finger. In other words, the gesture may be defined by motion following a touch thereby forming a continuous, moving touch event defining a moving series of touch positions. The gesture may represent a series of unbroken touch events, or in some cases a combination of separate touch events.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, in which certain elements of an apparatus 50 for facilitating selection of a predefined amount of zooming with a pinching gesture are depicted. The apparatus 50 of Figure. 2 may be employed, for example, in conjunction with the mobile terminal 10 of FIG. 1. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus 50 for facilitating selection of a predefined amount of zooming with a gesture, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for facilitating selection of a predefined amount of zooming is provided and may include or otherwise be in communication with a processor 52, a user interface 54, a communication interface 56 and a memory device 58. In some embodiments, the processor 52 (and/or co-processors or any other processing circuitry assisting or otherwise associated with the processor 52) may be in communication with the memory device 58 via a bus for passing information among components of the apparatus 50. The memory device 58 may include, for example, one or more volatile and/or non-volatile memories. In other words, for example, the memory device 58 may be an electronic storage device (e.g., a computer readable storage medium) comprising gates configured to store data (e.g., bits) that may be retrievable by a machine (e.g., a computing device like the processor 52). The memory device 58 may be configured to store information, data, applications, instructions or the like for enabling the apparatus to carry out various functions in accordance with an example embodiment of the present invention. For example, the memory device 58 could be configured to buffer input data for processing by the processor 52. Additionally or alternatively, the memory device 58 could be configured to store instructions for execution by the processor 52.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 52 may be embodied in a number of different ways. For example, the processor 52 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 52 may include one or more processing cores configured to perform independently. A multi-core processor may enable multiprocessing within a single physical package. Additionally or alternatively, the processor 52 may include one or more processors configured in tandem via the bus to enable independent execution of instructions, pipelining and/or multithreading.

In an example embodiment, the processor 52 may be configured to execute instructions stored in the memory device 58 or otherwise accessible to the processor 52. Alternatively or additionally, the processor 52 may be configured to execute hard coded functionality. As such, whether configured by hardware or software methods, or by a combination thereof, the processor 52 may represent an entity (e.g., physically embodied in circuitry) capable of performing operations according to an embodiment of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the algorithms and/or operations described herein when the instructions are executed. However, in some cases, the processor 52 may be a processor of a specific device (e.g., a mobile terminal or other computing device), such as processor 20 of mobile terminal 10 of FIG. 1, adapted for employing an embodiment of the present invention by further configuration of the processor 52 by instructions for performing the algorithms and/or operations described herein. The processor 52 may include, among other things, a clock, an arithmetic logic unit (ALU) and logic gates configured to support operation of the processor 52.

Meanwhile, the communication interface 56 may be any means such as a device or circuitry embodied in either hardware or a combination of hardware and software that is configured to receive and/or transmit data from/to a network and/or any other device or module in communication with the apparatus 50. In this regard, the communication interface 56 may include, for example, an antenna (or multiple antennas) and supporting hardware and/or software for enabling communications with a wireless communication network. Additionally or alternatively, the communication interface 56 may include the circuitry for interacting with the antenna(s) to cause transmission of signals via the antenna(s) or to handle receipt of signals received via the antenna(s). In some environments, the communication interface 56 may alternatively or also support wired communication. As such, for example, the communication interface 56 may include a communication modem and/or other hardware/software for supporting communication via cable, digital subscriber line (DSL), universal serial bus (USB) or other mechanisms.

The user interface 54 may be in communication with the processor 52 to receive an indication of a user input at the user interface 54 and/or to cause provision of an audible, visual, mechanical or other output to the user. As such, the user interface 54 may include, for example, a keyboard, a mouse, a joystick, a display, a head mounted display, a touch screen(s), touch areas, soft keys, a microphone, a speaker, or other input/output mechanisms. Alternatively or additionally, the processor 52 may comprise user interface circuitry configured to control at least some functions of one or more elements of the user interface, such as, for example, a speaker, ringer, microphone, display, and/or the like. The processor 52 and/or user interface circuitry comprising the processor 52 may be configured to control one or more functions of one or more elements of the user interface through computer program instructions (e.g., software and/or firmware) stored on a memory accessible to the processor 52 (e.g., memory device 58, and/or the like).

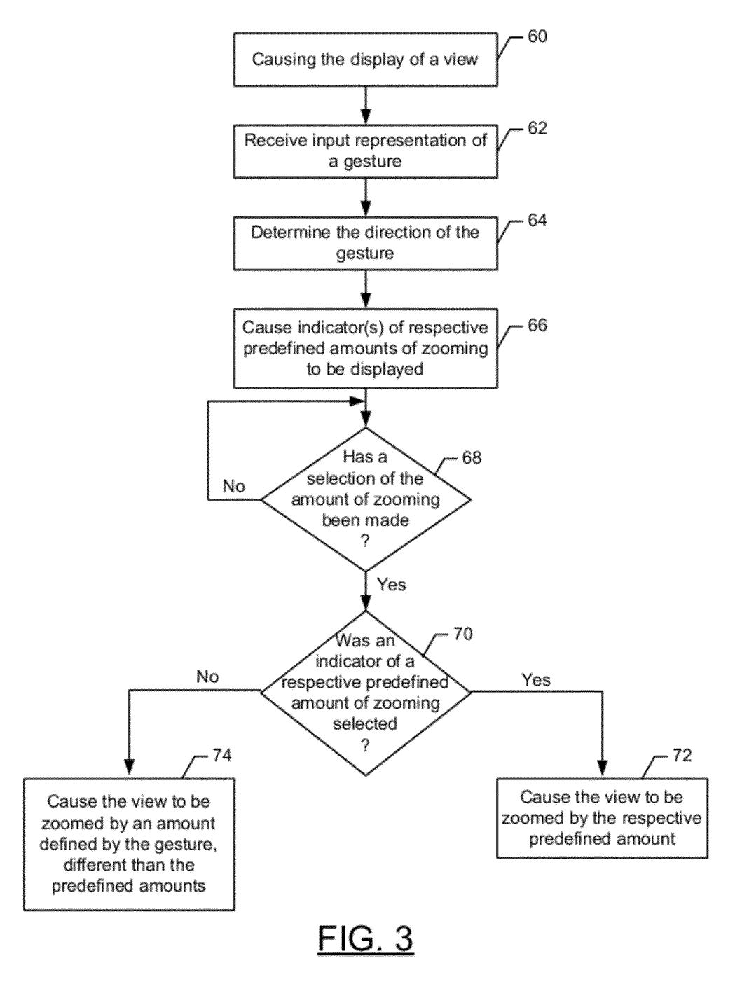

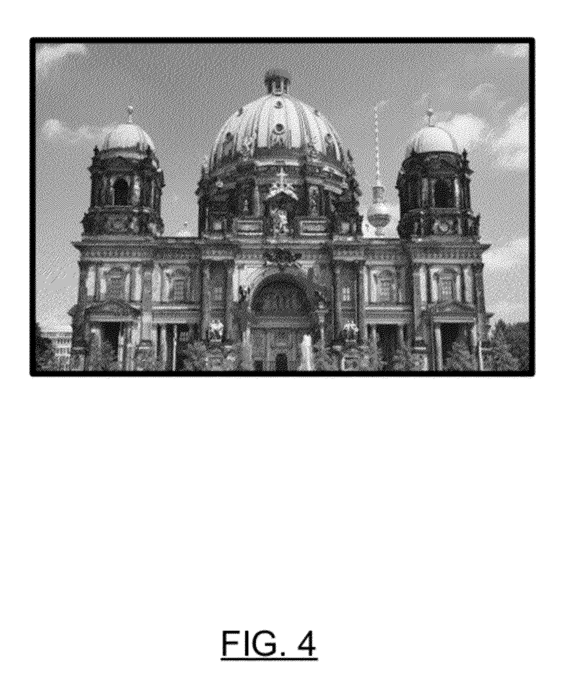

Referring now to FIG. 3, the operations performed by an apparatus 50 in accordance with one example embodiment of the present invention are shown. In this regard, the apparatus may include means, such as the processor 52, the user interface 54 or the like, for causing the display of a view, such as an image or other types of views including a view of a map, a calendar or the like. See operation 60 of FIG. 3. In this regard, the view may be displayed upon a touch screen display, such as display 28 of FIG. 1. As such, the apparatus 50 may also include means, such as the processor 52, the user interface 54 or the like, for receiving input representative of a gesture. See operation 62 of FIG. 3. In the embodiment described below, the gesture may be a pinching gesture, although other types of gestures, such as a tap, a double tap, a swipe with two fingers, the application of different amounts of force directed toward or into the display or the like, may be utilized in order to provide input regarding zooming of a view. As shown in FIG. 4 in which an image is displayed upon a touch screen display, the user may provide input regarding the manner in which the image is to be zoomed, such as by being either zoomed in to view a finer level of detail of a portion of the image or zoomed out so as to have a larger field of view, by providing a pinching gesture to the touch screen display. A pinching gesture may be provided in various manners, but is typically provided by the placement of two fingers on or near the touch screen display followed by the subsequent movement of the fingers either toward one another in order to cause the view to be zoomed out or away from one another in order to cause the view to be zoomed in. While the pinching gesture is generally provided (and, by way of example, will be hereinafter discussed) by the placement of two of the user's fingers upon or near the touch screen display, the pinching gesture may be performed by other types of pointing devices, such as styluses, pens, pencils or the like, that may be brought into operative contact with the touch screen display and then moved in a pinching gesture either toward one another or away from one another to define the desired amount of zooming. By way of example, FIG. 4 illustrates with an X the locations at which the user touches the touch screen display in preparation for a pinching gesture.

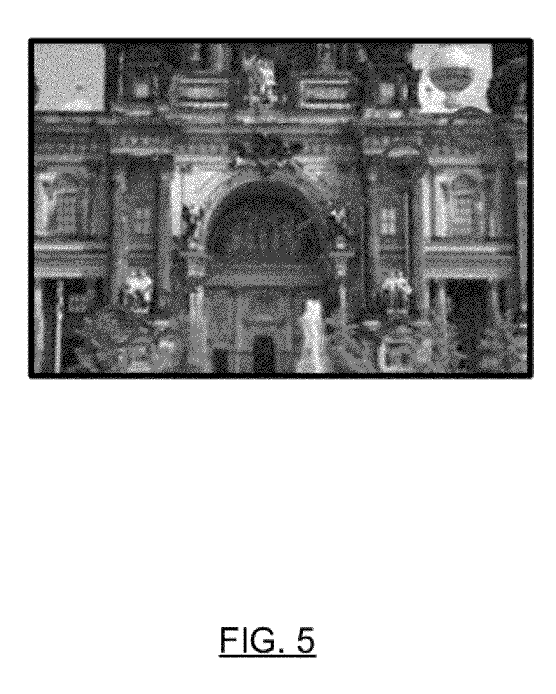

In accordance with an example embodiment of the present invention, the apparatus 50 may include means, such as the processor 52, the user interface 54 or the like, for causing one or more indicators of respective amounts of zooming to be displayed. See operation 66 of FIG. 3. As shown in FIG. 5, for example, indicators representative of zooming to 200% and zooming to 300% are shown, although other non-numeric indicators may be provided as described below. While two indicators of predefined amounts of zooming are shown in example of FIG. 5, any number of indicators of different predefined amounts of zooming may be displayed in other embodiments. The indicators are positioned upon the display at locations that are spaced apart such that a pinching gesture that begins at the initial locations marked by a dashed X and results in the placement of the user's fingers upon the indicators will cause the predefined amount of zooming to occur. In this regard, the amount of zooming may defined by the magnitude of the pinching gesture, that is, the extent by which the user's fingers move, either toward one another or away from one another, with greater amounts of zooming provided in response to a pinching gesture in which the user's fingers are moved a relatively large amount and lesser amounts of zooming provided in response to a pinching gesture in which the user's fingers are moved by a smaller distance. As shown in FIG. 5, for example, the indicators associated with zooming to 200% are closer together and closer to the original locations at which the user touched the touch screen display as designated by the dashed X's than the indicators associated with zooming to 300%. Alternatively, the amount of zooming may be defined by the speed of the pinching gesture with greater amounts of zooming provided in response to a pinching gesture in which the user's fingers move faster and lesser amounts of zooming provided in response to a pinching gesture in which the user's fingers move slower. The indicators that are caused to be displayed may also or alternatively be dependent upon other parameters associated with the gesture, such as the direction of the gesture, the location of the gesture or the like.

In one embodiment, the indicator may be displayed upon the initial touch of the touch screen display with a pair of fingers or the like. In other embodiments, the indicators are only displayed once the apparatus 50 detects movement of the fingers in accordance with a predefined gesture, such as a predefined direction indicative of a predefined type of pinching gesture, such as a pinching gesture in which the fingers are spread further apart or a pinching gesture in which the fingers are brought closer to one another. As such, in an embodiment in which the gesture that controls zooming of a view is a pinching gesture, the apparatus 50 may optionally include means, such as the processor 52, user interface 54 or the like, for determining the direction of the pinching gesture. See operation 64 of FIG. 3. In the embodiment of FIG. 5 in which the fingers are spread apart by being moved away from one another, such as by movement of the fingers from the initial positions indicated by the dashed X in an outward direction indicated by the arrows to the current position of the fingers as indicated by the solid Xs, the apparatus 50, such as a processor 52 or the like, may determine that the pinching gesture is a pinching gesture associated with zooming in and, as such, may cause the indicators associated with zooming in to be displayed. In one embodiment, only those indicators associated with the particular type of pinching gesture are caused to be displayed, such as only the indicators associated with zooming in an embodiment as shown in FIG. 5 in which the pinching gesture is determined to be associated with zooming in.

The apparatus 50, such as the processor 52, user interface 54 or the like, may also include means for causing the display of the view to be zoomed in a manner consistent with the gesture, such as represented by the current position of the user's fingers. As such, a user may consider the view, as zoomed, to determine if the appropriate amount of zooming has been introduced or if further zooming, either in or out, is required. In the embodiment of FIG. 5 in which the user's fingers have moved to the locations marked by the solid Xs approximately halfway between their initial positions as designated by the dashed Xs and the position at which the amount of zooming would be 200%, as represented by the 200% indicator, the view that is displayed will have been magnified by about 150% based upon the current pinching gesture.

In an instance in which the user continues to spread their fingers apart so as to coincide with the indicators of zooming to 200%, the apparatus 50, such as a processor 52, the user interface 52 or the like, may cause the view that is displayed to zoom to 200% relative to the original view at the time that the pinching gesture was commenced. By including the indicators, the user need not be concerned that the amount of zooming is close to, but not, exactly the respective predefined amount. Instead, a gesture that results in the placement of the user's fingers upon a respective indicator will cause the image to be displayed in a manner so as to have the predefined amount of zooming.

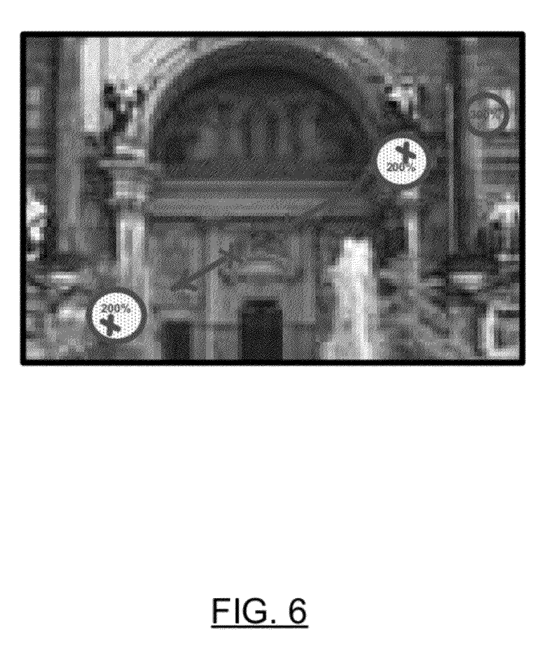

In order to continue to visually see and recognize the indicator once the gesture has brought the user's fingers to a position so as to overlie the indicator, the manner in which the indicator is displayed may be altered. Although the appearance of the indicator may be altered in various manners, the apparatus 50 may include means, such as processor 52, user interface 54 or the like, for causing the indicator to be highlighted, such as indicated by the cross hatching of FIG. 6, in response to receiving input co-located with the respective indicator. Additionally, or alternatively, the apparatus 50 may include means, such as the processor 52, the user interface 54 or the like, for causing the indicator to be enlarged, such as also shown in FIG. 6 in response to receiving input co-located with the respective indicator.

Further movement of the user's fingers beyond the indicator associated with zooming to 200% in FIG. 6 will cause the view to be zoomed in to greater percentages, while movement of the user's fingers closer together will again cause the view to be zoomed out to smaller percentages. In order to select the particular amount of zooming of the view, a predefined input may be provided, such as by lifting the user's fingers from the touch screen display or otherwise terminating the pinching gesture. In this embodiment, the amount of zooming of the view that is then caused to be displayed is defined by the magnitude of the pinching gesture as defined by the extent of movement of the user's fingers based, for example, upon the position of the user's fingers at the time that the user's fingers were lifted from the touch screen display relative to the position of the user's fingers at the inception of the pinching gesture.

As shown in FIG. 3, the apparatus 50 may include means, such as the processor 52 or the like, for determining if a selection for the amount of zooming has been made, such as by determining if the pinching gesture has been completed by lifting of the user's fingers from the touch screen display. See operation 68. If a selection has not yet been made as evidenced by the continuation of the gesture, the apparatus 50, such as the processor 52, the user interface 54 or the like, may continue to monitor the gesture and to dynamically modify the image that is caused to be displayed based upon the current gesture. If a selection is determined to have been made, however, the apparatus 50 may include means, such as the processor 52 or the like, for determining if an indicator of a respective predefined amount of zooming was selected. See operation 70 of FIGS. 3.

If an indicator of a respective predefined amount of zooming was selected, the apparatus 50 may include means, such as the processor 52, user interface 54 or the like, for causing the view that is displayed to be zoomed to the respective predefined amount. See operation 72 of FIG. 3. For example, in an instance in which the pinching gesture is completed with the user's fingers upon the 200% indicator as shown in FIG. 6, the view that is displayed will be correspondingly zoomed to 200%. By relying upon selection of the respective indicators to define the amount of zooming, the resulting image is zoomed in the manner anticipated by the user and the amount of visual artifacts, jagged lines or the like may be reduced so as to improve the quality of the resulting view. Alternatively, if the selection is not of an indicator of a respective predefined amount of zooming, but if the gesture is, instead, completed by the lifting of the user's fingers from the touch screen display while the user's fingers are not co-located with an indicator of a predefined amount of zooming, the apparatus 50 may include means, such as the processor 52, user interface 54 or the like, for causing the view to be zoomed by an amount defined by the gesture. See operation 74 of FIG. 3. In this regard, the amount will be different than the predefined amounts associated with the indicators since an indicator was not selected. In the amount illustrated in FIG. 5, for example, if the pinching gesture were completed by lifting the user's fingers from the touch screen display while at the positions marked by the solid X, the resulting the view would be caused to be magnified by about 150%. In this embodiment, a user is therefore not limited to the selection of one or more predefined amounts of zooming with the gesture, but is also allowed to select amounts of zooming that are different than the predefined amounts with the gesture. As such, a user may enjoy not only the ability to readily select one or more predefined amounts of zooming with a gesture, but may also enjoy the freedom of selecting any other amount of zooming with the gesture.

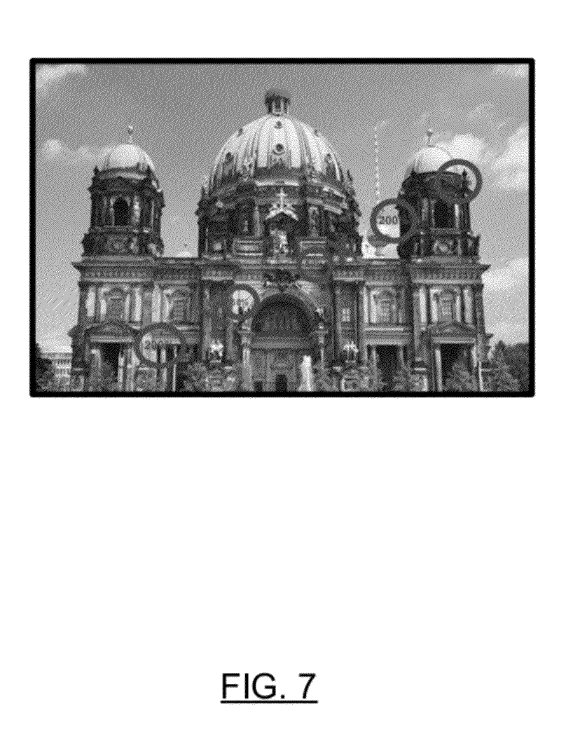

Although example embodiments of the present invention have been described above in conjunction with the screen displays of FIGS. 4-6, the method, apparatus and computer program product may include additional or alternative features in other embodiments. As shown in FIG. 7, for example, indicators of a respective predefined amount of zooming may be displayed in the response to receiving input representative of a pinching gesture. In this embodiment, the apparatus 50, such as the processor 52, user interface 54 or the like, does not first determine the direction of the pinching gesture so as to display only the indicators of respective predefined amounts of zooming that are associated with the direction of the pinching gesture, such as shown in FIGS. 5 and 6. Instead, the apparatus 50, such as the processor 52, user interface 54 or the like, may display a plurality of indicators of respective predefined amounts of zooming including indicators for both zooming in and zooming out regardless of the direction of the pinching gesture. In this embodiment, the user may be initially informed of all of the predefined amounts of zooming so as to facilitate selection from the respective indicators, if so desired.

While the view that is displayed and zoomed in accordance with an example embodiment of the present invention may be any of a wide variety of different views, in the example embodiment of FIGS. 4-7, a photographic image is shown for purposes of example. Other examples of a view that may be displayed and zoomed include a view of a calendar, a map or the like as well as any other visual areas, canvasses or views that may be presented by a user interface. As such, while the indicators of respective predefined amounts of zooming may be defined in terms of predefined numerical percentages as shown in FIGS. 5-7 and as described above, the predefined amounts of zooming associated with the respective indicator may be defined in other manners, such as in terms of a predetermined level of detail that is to be displayed. In regards to a calendar, for example, the predefined amounts of zooming may be defined in terms of years, months, weeks, days, hours, etc. By way of example, an instance in which the initial view of a calendar is a view of a particular month, predefined indicators for zooming out may correspond to one year including the particular month and multiple years including the particular month, while indicators indicative of zooming in from the particular month may include weeks within the particular month, days within the particular month, hours within the particular month or the like. By way of another example, the initial view may be a map such that the predefined map for zooming may be defined in terms of countries, states or provinces, regions, cities, subdivisions or the like. As an example in which the initial view is a map of a particular country, indicators of respective predefined amounts of zooming out may include a continent including the particular country and the world, while indicators of respective predefined amounts of zooming in may include states or provinces, regions, cities, subdivisions, streets or the like. As such, the method and apparatus of example embodiments of the present invention may include indicators of respective predefined amounts of zooming that are defined in a variety of different manners depending, for example, upon the type of view that is displayed and is to be zoomed. The use of these indicators may not only increase the precision with which zooming may be accomplished, but the selection of the indicators may also increase the speed of the zooming, such as by permitting zooming from a view of a city to a street or vice versa with the selection of a single indicator.

As described above, FIG. 3 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (either mobile or fixed) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving input representative of a gesture associated with zooming of a view;
causing, with a processor, one or more indicators of respective predefined amounts of zooming to be displayed in response to receiving the input; and
in response to selection of a respective indicator, causing the view to be zoomed in accordance with the predefined amount of zooming associated with the respective indicator.

2. A method according to claim 1 further comprising causing the view to be zoomed by an amount defined by the gesture and different than the predefined amounts of zooming in an instance in which the one or more indicators are not selected.

3. A method according to claim 1 wherein receiving input representative of a gesture comprises receiving input representative of a pinching gesture associated with zooming of the view.

4. A method according to claim 3 further comprising determining a direction of the pinching gesture, wherein the direction of the pinching gesture indicates whether the view is to be zoomed in or zoomed out, and wherein causing one or more indicators to be displayed comprises causing only the one or more indicators associated with the direction of the pinching gesture to be displayed.

5. A method according to claim 3 wherein causing one or more indicators to be displayed comprises causing one or more indicators of respective amounts of zooming in and zooming out to be displayed regardless of a direction of the pinching gesture.

6. A method according to claim 1 wherein the predefined amount of zooming comprises a predefined numerical percentage or a predefined level of detail.

7. A method according to claim 1 further comprising causing an indicator to be highlighted in response to receiving input co-located with the respective indicator.

8. A method according to claim 1 further comprising causing an indicator to be enlarged in response to receiving input co-located with the respective indicator.

9. An apparatus comprising:
at least one processor; and
at least one memory including computer program code configured to, with the at least one processor, cause the apparatus to perform at least the following:
receive input representative of a gesture associated with zooming of a view;
cause one or more indicators of respective predefined amounts of zooming to be displayed in response to receiving the input; and
in response to selection of a respective indicator, cause the view to be zoomed in accordance with the predefined amount of zooming associated with the respective indicator.

10. An apparatus according to claim 9 wherein the at least one memory including computer program code is further configured to, with the at least one processor, cause the apparatus to cause the view to be zoomed by an amount defined by the gesture and different than the predefined amounts of zooming in an instance in which the one or more indicators are not selected.

11. An apparatus according to claim 9 wherein the at least one memory including computer program code is configured to, with the at least one processor, cause the apparatus to receive input representative of a gesture by receiving input representative of a pinching gesture associated with zooming of the view.

12. An apparatus according to claim 11 wherein the at least one memory including computer program code is further configured to, with the at least one processor, cause the apparatus to determine a direction of the pinching gesture, wherein the direction of the pinching gesture indicates whether the view is to be zoomed in or zoomed out, and wherein the at least one memory including computer program code is configured to, with the at least one processor, cause the apparatus to cause one or more indicators to be displayed by causing only the one or more indicators associated with the direction of the pinching gesture to be displayed.

13. An apparatus according to claim 11 wherein the at least one memory including computer program code is further configured to, with the at least one processor, cause the apparatus to cause one or more indicators to be displayed by causing one or more indicators of respective amounts of zooming in and zooming out to be displayed regardless of a direction of the pinching gesture.

14. An apparatus according to claim 9 wherein the predefined amount of zooming comprises a predefined numerical percentage or a predefined level of detail.

15. An apparatus according to claim 9 wherein the at least one memory including computer program code is further configured to, with the at least one processor, cause the apparatus to cause an indicator to be highlighted in response to receiving input co-located with the respective indicator.

16. An apparatus according to claim 9 wherein the at least one memory including computer program code is further configured to, with the at least one processor, cause the apparatus to cause an indicator to be enlarged in response to receiving input co-located with the respective indicator.

17. A computer program product comprising at least one tangible computer-readable storage medium having computer-readable program code portions stored therein, the computer-readable program code portions comprising:
program code instructions configured to receive input representative of a gesture associated with zooming of a view;
program code instructions configured to cause one or more indicators of respective predefined amounts of zooming to be displayed in response to receiving the input; and
program code instructions configured to cause the view, in response to selection of a respective indicator, to be zoomed in accordance with the predefined amount of zooming associated with the respective indicator.

18. A computer program product according to claim 17 wherein the computer-readable program code portions further comprise program code instructions configured to cause the view to be zoomed by an amount defined by the gesture and different than the predefined amounts of zooming in an instance in which the one or more indicators are not selected.

19. A computer program product according to claim 17 wherein the program code instructions configured to receive input representative of a gesture comprise program code instructions configured to receive input representative of a pinching gesture associated with zooming of the view.

20. A computer program product according to claim 19 wherein the computer-readable program code portions further comprise program code instructions configured to determine a direction of the pinching gesture, wherein the direction of the pinching gesture indicates whether the view is to be zoomed in or zoomed out, and wherein the program code instructions configured to cause one or more indicators to be displayed comprise program code instructions configured to cause only the one or more indicators associated with the direction of the pinching gesture to be displayed.
